(19) United States
(12) Patent Application Publication
(10) Pub. No.: US 2023/0085510 A1
(43) Pub. Date: Mar. 16, 2023

(54) APPARATUS AND METHOD TO DETECT AIRBORNE OBJECTS USING WAVEFORM ANALYSIS OF REFLECTED AND SCATTERED ELECTROMAGNETIC RADIATIONS

(71) Applicants: Research Foundation of the City University of New York, New York, NY (US); Atolla Tech LLC, Rockville Centre, NY (US)

(72) Inventors: Morann Sonia Dagan, New York, NY (US); Andrii Golovin, New York, NY (US); Fred Moshary, New Brunswick, NJ (US)

(21) Appl. No.: 17/790,285

(22) PCT Filed: Dec. 31, 2020
(86) PCT No.: PCT/US20/67705

§ 371 Date: Jun. 30, 2022

Related U.S. Application Data
(60) Provisional application No. 62/955,661, filed on Dec. 31, 2019.

(51) Int. Cl. G01S 17/88; G01S 7/481

(52) U.S. Cl. CPC G01S 17/88; G01S 7/4816; G01S 7/4817

(57) ABSTRACT

A method for detecting an airborne object. Electromagnetic radiation is emitted from a transmitter to overlap with a receiver's field of view. When an airborne object enters the field of view, the electromagnetic radiation interacts with moving airfoils on the airborne object to produce reflected and scattered electromagnetic radiation. The reflected and scattered electromagnetic radiation is analyzed to detect, classify and/or determine the orientation of the airborne object.

### CROSS-REFERENCE TO RELATED APPLICATIONS

This application claims priority to and is a non-provisional of U.S. Patent application 62/955,661 (filed Dec. 31, 2019), the entirety of which is incorporated herein by reference.

### STATEMENT OF FEDERALLY SPONSORED RESEARCH OR DEVELOPMENT

This invention was made with government support under grant number 1842973 awarded by the National Science Foundation. The government has certain rights in the invention.

### BACKGROUND OF THE INVENTION

The subject matter disclosed herein relates to optical systems for detecting, counting and/or classifying airborne objects that having moving airfoils, such as wings or propellers.

Effective pest control in agriculture is imperative for growers to prevent major crop loss. Certain pests are responsible for such significant crop damage which provokes growers to invest in expensive and time-consuming measures to minimize the pest's effects. Insects fly into a crop field in search of food, lay their larvae in the target crop and thus begin the damage. The reaction of the grower to the pest is time-sensitive; the timing of the treatment application will directly determine its effectiveness. Having the knowledge of when the initial pest has entered the crop field is ideal, however, the sooner there is any knowledge of pest activity, the better a grower can mitigate its effects. Crop fields with larger acreage, in more remote locations, and/or with rougher terrain present bigger challenges to the grower in scouting and mitigating the threatening pest's activity, leaving the grower in search of better solutions.

Detection of pests is an essential, but manual, task that is prone to human error. Growers rely on scouters and traps to gain knowledge of pest activity. The information collected by these resources aides the grower in determining whether to apply a chemical treatment. Scouters are specialized labor that routinely scan a field, checking for any signs of pests. If found, examination of the affected crop collected by the scouters is then necessary to determine the level of infestation through investigation of the pest life cycles discovered inside the damaged crop. The result of the analysis is then given to the person responsible for the treatment procedure; a delayed time-gap is evident in this method, between occurrence of pest damage and response of action. Insect traps are often used as well for establishing infestation levels. They are not favorable amongst the larger farms with remote crop fields due to the number of traps that would need to be installed and serviced as well as the inaccuracy and delay of the results. Growers need to rely on expert labor when using traps for the collection, dissection and identification of the insects caught. Both methods described are point source measurements; they may show no results of infestation where they are situated, while nearby an infestation has occurred. Scouters and traps, therefore, incur high labor costs; requiring several expert personnel to travel through fields that may be hundreds of acres in size to collect data and then further analyze the information for calculation of the infestation level. This time delay in information instigates growers to use harsher chemicals tackle the later stage infestations, yet more regulations are being enforced on growers for using more natural materials. Growers, for so many reasons, are eager for a solution that mitigates the pest's effects while holding up to the tightening pressure from regulators and consumers. An improved system would be advantageous.

The discussion above is merely provided for general background information and is not intended to be used as an aid in determining the scope of the claimed subject matter.

### SUMMARY

A method for detecting an airborne object. Electromagnetic radiation is emitted from a transmitter to overlap with a receiver's field of view. When an airborne object enters the field of view, the electromagnetic radiation interacts with moving airfoils on the airborne object to produce reflected and scattered electromagnetic radiation. The reflected and scattered electromagnetic radiation is analyzed to detect, classify and/or determine the orientation of the airborne object.

In a first embodiment, a method for detecting an airborne object is provided. The method comprising: emitting electromagnetic radiation as a transmitter beam of a predetermined wavelength from a transmitter comprising a radiation source selected from a group consisting of a continuous wave mode radiation source, a pulse mode radiation source and a combination thereof, wherein the transmitter beam overlaps with a field of view of a receiver and an airborne object is present within the field of view, the airborne object comprising a moving airfoil selected from a group consisting of at least one moving wing and at least one moving propeller, wherein the electromagnetic radiation interacts with the moving airfoil to produce reflected and scattered radiation; detecting, with the receiver, the reflected and scattered radiation, wherein the receiver comprises; an optical receiving antenna for receiving the reflected and scattered radiation, thereby producing collected radiation; a photodetector for converting the collected radiation to an analog signal; a digitizer for converting the analog signal to a digital signal; and a computer processor. The method comprising analyzing, with the computer processor, the digital signal to produce analyzed data.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is a schematic diagram depicting a top view position of a system to detect reflected and scattered radiation form an airborne object,

FIG. 1B depicts a transmitter configuration with two sources of electromagnetic radiation for dual mode operation;

FIG. 1C is a schematic diagram depicting a top view position of a system to detect reflected and scattered radiation form an airborne object, wherein an airborne object is present;

FIG. 1D is a schematic diagram of a receiver for use with the system of FIG. 1A and FIG. 1C;

FIG. 1E is schematic diagram depicting a horizontal side view position of a system to detect reflected and scattered radiation form an airborne object, wherein an airborne object is present;

FIG. 2A depicts a digitized photodetector signal measured from a fruit fly with the top view position of the transmitter and receiver;

FIG. 2B depicts the FFT spectrum of the digitized signal depicted in FIG. 2;

FIG. 3A depicts a digitized photodetector signal measured from a fruit fly with a horizontal side view position of the transmitter and receiver;

FIG. 3B depicts the FFT spectrum of the digitized signal depicted in FIG. 3A;

FIG. 4 is a depiction of a winged insect showing a pattern of wing movement during flight;

FIG. 5A is a depiction of digitized photodetector signal from an insect measured from a top view position while the insect is in a first orientation relative to the transmitter optical axis of the transmitter;

FIG. 5B depicts a FFT spectrum of the digitized signal depicted in FIG. 5A;

FIG. 6A is a depiction of digitized photodetector signal from an insect measured from a horizontal side view position while the insect is in a second orientation relative to the transmitter optical axis of the transmitter;

FIG. 6B depicts a FFT spectrum of the digitized signal depicted in FIG. 6A;

FIG. 7A is a digitized photodetector signal measured from a ladybug with the top view position of the transmitter and receiver;

FIG. 7B depicts the FFT spectrum of the digitized signal depicted in FIG. 7A;

FIG. 8A is a digitized photodetector signal measured from a horizontal side view of a ladybug;

FIG. 8B depicts the FFT spectrum of the digitized signal depicted in FIG. 8A;

FIG. 9A and FIG. 9B are schematic diagrams of a system for drone propeller measurements;

FIG. 10A is a digitized photodetector signal measured from a propeller of the drone;

FIG. 10B depicts the FFT spectrum of the digitized signal depicted in FIG. 11; and

FIG. 11A and FIG. 11B depict the use of a scanner to reposition the transmitter and receiver of the system.

### DETAILED DESCRIPTION OF THE INVENTION

This disclosure provides a method and apparatus to detect, localize, classify, and/or count airborne objects (natural or man-made) using waveform analysis of radiation reflected and scattered by the airborne object's dynamically moving airfoil(s). Examples of moving airfoils are wings and propellers. The apparatus is a non-destructive remote sensing electro-optics system for waveform analysis for classification of airborne objects.

Electro-optical systems are useful apparatuses for remote sensing applications, which use electromagnetic radiation to probe particular parameters of objects in non-disturbing and non-destructive modes of operations. The signal from the scattered probing radiation can be analyzed to count the airborne objects and, in some embodiments, classify their particular parameters and find their location and orientation. Particularly in this disclosure, the unique waveform of scattered radiation, wing beat frequency (WBF), location, and body orientation can be measured remotely for winged animals (e.g. insects, birds, bats etc.) or drones (e.g. winged drones or propeller-driven drones).

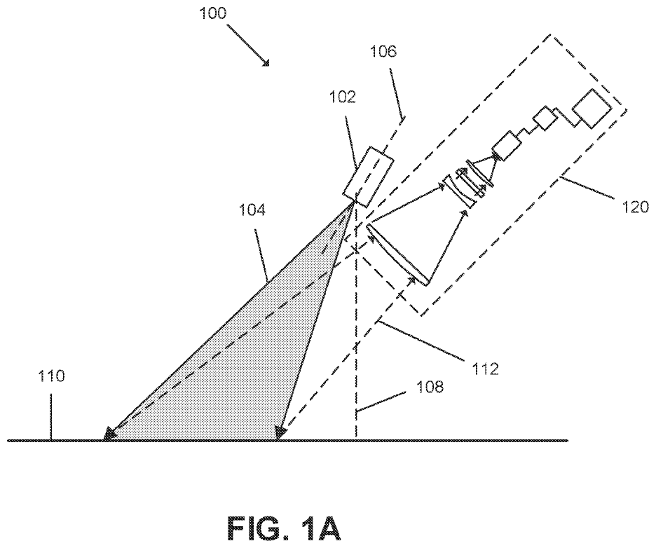

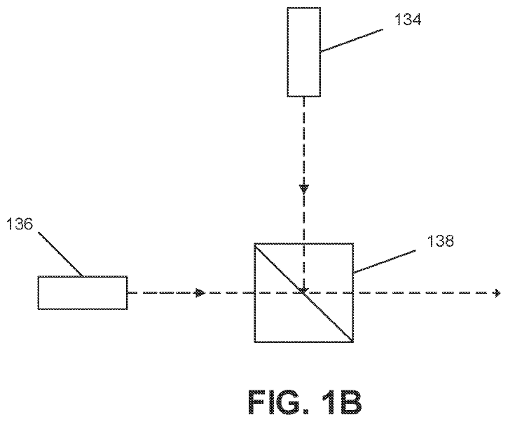

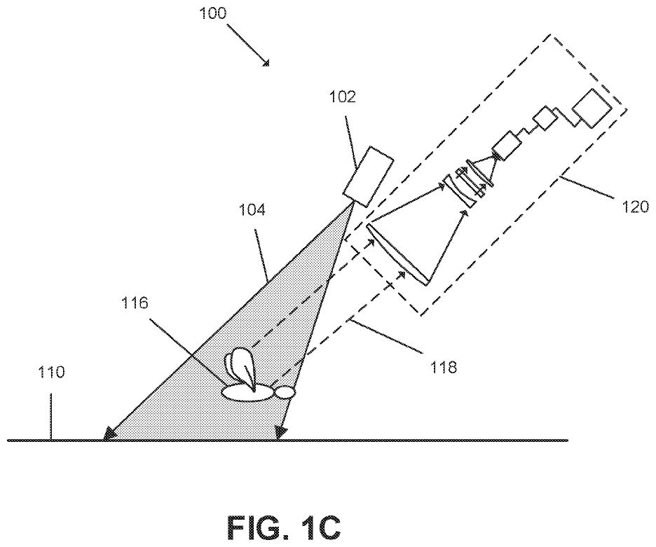

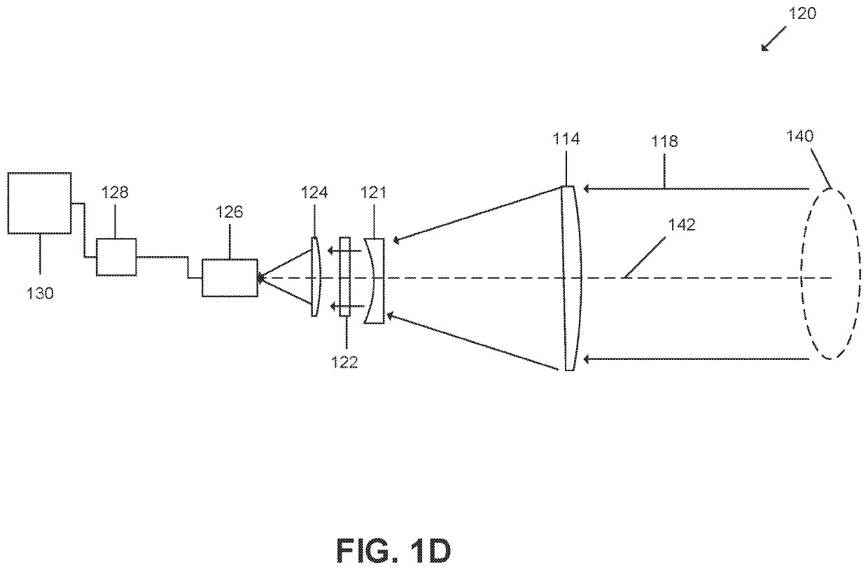

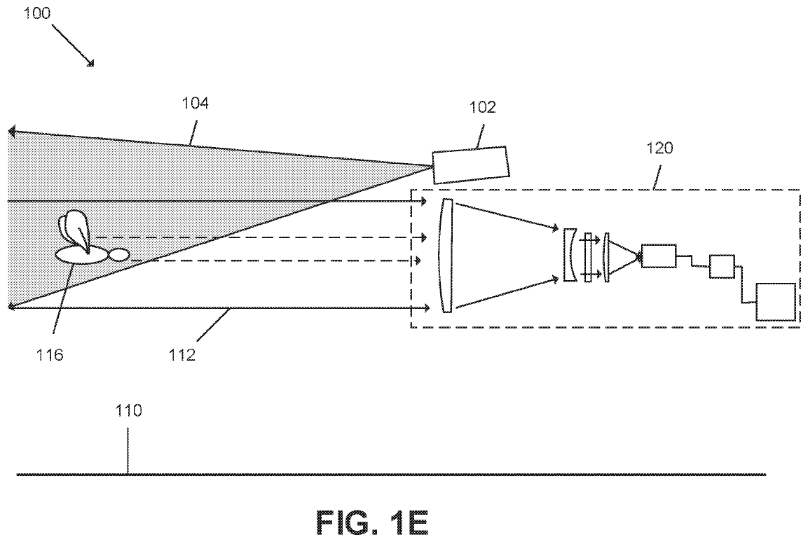

FIG. 1A depicts a configuration wherein a system 100 is disposed above a zone that is to be monitored for airborne objects. As used in this specification, this configuration is referred to as the “top view position.” The system 100 comprises a transmitter 102 which comprises an electromagnetic radiation source (e.g. a semiconductor laser or a fiber laser) and beam directing optical components. The transmitter 102 operates at a predetermined wavelength (e.g. 810 nm or 1550 nm) or within a narrow band (e.g. within 5 nm) of a predetermined wavelength. The predetermined wavelength may be selected from infrared (0.3 cm to 780 nm), visible (780 nm to 390 nm) or ultraviolet (390 nm to 100 nm).

The transmitter 102 may operate in continuous wave (cw) mode for the subsequent signal analysis in the frequency domain. In the case of a camouflaged drone appearing as a natural creature, such as an insect or bird, higher frequencies unique to drones may exist in the signal, therefore, operation in continuous wave mode allows for the system 100 to distinguish between flapping wings of mechanical drones and their natural counterparts. Additionally, mechanical drones provide highly cyclical signals which are distinct from signals from natural creatures which, due to their biological origins, have a larger degree of variability in their waveform patterns, evident in the time and frequency domain. The transmitter 102 may also operate in a pulse mode for the subsequent signal analysis in the frequency domain. This mode of operation is desirable when the pulse frequency of the transmitter 102 is at least double the highest waveform frequency in the signal (i.e. Nyquist frequency). For example, agricultural insect pests have a maximum WBF of 1 kHz, thereby making it feasible to implement a pulsed laser source with a minimum frequency of 2 kHz.

The operation of the transmitter 102 in pulsed mode facilitates data analysis in the time domain. This analysis allows for localization of the airborne object. The determination of the airborne object's location is coordinated using pulses of probing electromagnetic radiation. The time t between the probing pulse and “echo” pulse of scattered radiation may be measured to calculate distance S between the transmitter 102 and airborne object:

$$S = c \frac{t}{2} ,$$

where c≈3·10⁸ m/s is the phase velocity of electromagnetic radiation in air. FIG. 1A depicts a configuration of a single electromagnetic source that may be internally switched between cw mode and pulsed mode.

In the embodiment of FIG. 1A, the transmitter 102 produces a divergent beam 104 that defines the zone that is being monitored. The transmitter 102 has a transmitter optical axis 106 that deviates from a vertical axis 108 by an angle θ. For example, the angle may be between 1° and 90°. When an airborne object is not present, the beam 104 strikes a horizontal surface 110 and reflected and scattered radiation 112 is produced. A subset of the reflected and scattered radiation 112 is captured by receiver 120 for subsequent data analysis. In the embodiment of FIG. 1A (i.e. the top view position) the horizontal surface 110 may be, for example, the ground or floor.

FIG. 1B depicts a transmitter configuration with two radiation sources 134, 136 of electromagnetic radiation for dual mode operation. When waveform frequencies of the scattered radiation are equal or higher than the frequency of pulses from the available pulse transmitter, the cw source in the transmitter is used for the waveform analysis in the frequency domain. Therefore, a cw source may be used for identifying features that determine classification and count, including WBF or propeller frequency, orientation of the airborne object in space, size of the airborne object, and species or drone model. The pulsed source may be used for localization of the airborne object in space as well as 3D modeling of the object in space. The electromagnetic radiation from the two radiation sources 134, 136 are combined onto the same transmitter beam using a beam splitter 138 as depicted in FIG. 1B.

FIG. 1C is similar to FIG. 1A except in that an airborne object 116 is present in the zone. In the embodiment of FIG. 1C, the airborne object 116 is a winged insect that is in flight, wherein the moving airfoils are moving wings. In another embodiment, the airborne object 116 is an aerial drone wherein the moving airfoils are moving propellers or mechanical wings. When the electromagnetic radiation from the beam 104 strikes the moving airfoil, the interaction of the electromagnetic radiation with the moving airfoil produces reflected and scattered radiation 118 which is distinct from the reflected and scattered radiation 112 that has not interacted with the moving airfoil. The reflected and scattered radiation 118 is subjected to data analysis in the receiver 120 which is shown in schematic detail in FIG. 1D.

FIG. 1D depicts the receiver 120 in further detail. The receiver 120 comprises of an optical receiving antenna 114, a photodetector 126, a digitizer 128 and a computer processor 130. The optical receiving antenna 114 (with a field of view 140 and a receiver optical axis 142) can be implemented using a reflector or lens which will depend on the application. The transmitter optical axis 106 projects the transmitter beam to overlap with the field of view 140. In FIG. 1D a Galilean design is represented, but a Newtonian design may be used as well for the purposes of detecting, classifying and/or counting airborne objects. Furthermore, the receiver 120 may include other optical components such as a collimating lens 121, an optical filter 122, and/or a focusing lens 124. In the embodiment of FIG. 1D, the reflected and scattered radiation 118 initially enters the optical receiving antenna 114 which focuses the reflected and scattered radiation 118 onto the collimating lens 121. The optical filter 122 selects for the predetermined wavelength that was emitted by the laser (e.g. for 810 nm). In the embodiment of FIG. 1D, the optical filter 122 is situated between the collimating lens 121 and the focusing lens 124. The focusing lens 124 focuses the reflected and scattered radiation 118 to an area within the photodetector 126. The photodetector 126 produces a corresponding analog electrical signal which is provided to the digitizer 128. The digitizer 128 converts the analog electrical signal to a digital electrical signal. The digital electrical signal is then provided to the computer processor 130 for further analysis.

FIG. 1E is similar to FIG. 1A except in that the beam 104 is projected in a horizontal direction. This provides sideways imaging of any airborne objects. As used in this specification, this configuration is referred to as the “horizontal side view.”

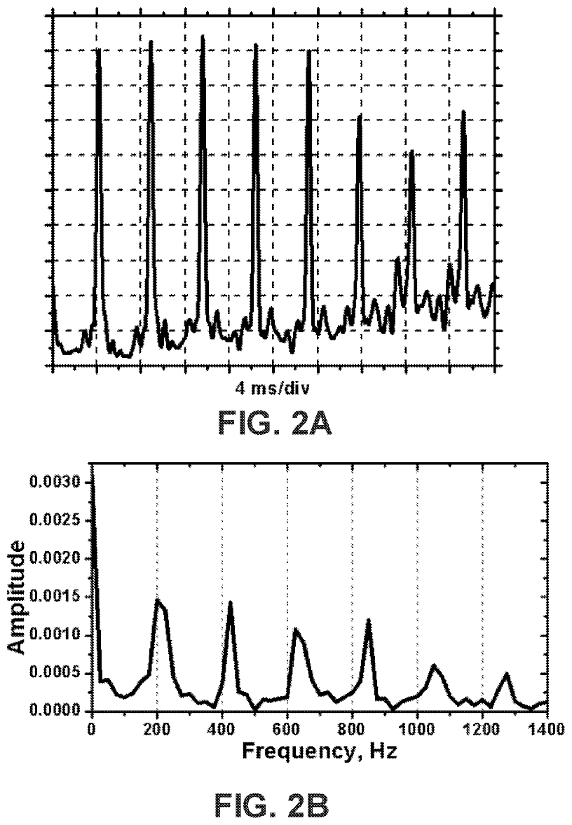

FIG. 2A depicts an oscilloscope signal collected in experiments using fruit flies, where the transmitter 102 and receiver 120 were installed in the top view position as in FIG. 1A. The waveform signal analysis in the time domain can be used to determine the size of airborne object body, the WBF and the orientation of the insect body. The signal shown in FIG. 2A demonstrates a low frequency base curve as well as a periodic series of high amplitude peaks with a period of 5 ms. The base curve corresponds to the radiation reflected by the body of the airborne object (providing data for determining size of airborne object body) and the periodic peaks correspond to the radiation reflected and scattered by the wings (i.e. the moving airfoils) when the airborne object flies into the field of view of the transmitter 102 in the horizontal plane (providing data for determining WBF and orientation of airborne object with respect to transmitter and receiver). In the example depicted, the insect wings have a wing beat period of T=5 ms which corresponds to a WBF of f=1/T=200 Hz.

FIG. 2B depicts a plot of amplitude vs frequency (i.e. frequency spectrum) which is calculated using fast Fourier transform (FFT) applied to the oscilloscope signal in FIG. 2A. The first harmonic with a frequency of 200 Hz demonstrates the highest amplitude of AC signal, which supports the estimation of the WBF found from the time sequence of peaks and known from published studies. The wing beat period and the WBF are characteristic of insect species.

The frequency spectrum of the wing beat period is a distinctive parameter of the insect's biological family, which can be used to classify insects flying over a terrain. The features of amplitude spectrum calculated using FFT allow for a number of determinations including WBF, harmonic amplitudes in the frequency domain, and convoluted signals showing count of objects. By understanding the convolution of signals for a uniform group of insects as well as collecting the results from a full field scan, one can evaluate the number of insects (e.g. count) in flight.

The features resulting from the airborne object's moving airfoils represented in the analysis of the waveform in the time and frequency domain are aggregated to represent a fingerprint (i.e. a waveform signature) for classification of an airborne object (i.e. identification of species or drone type/manufacturer). Additionally, one can classify the species of insect by analyzing the frequency spectrum. One can detect the presence of insects by noting the presence of a non-background signal that matches the wing beat period and frequency of interest. One can also count the number of insects that enters the field of view of the transmitter 102 by counting the number of non-background signals (that match the wing beat period and frequency of interest) obtained per unit time.

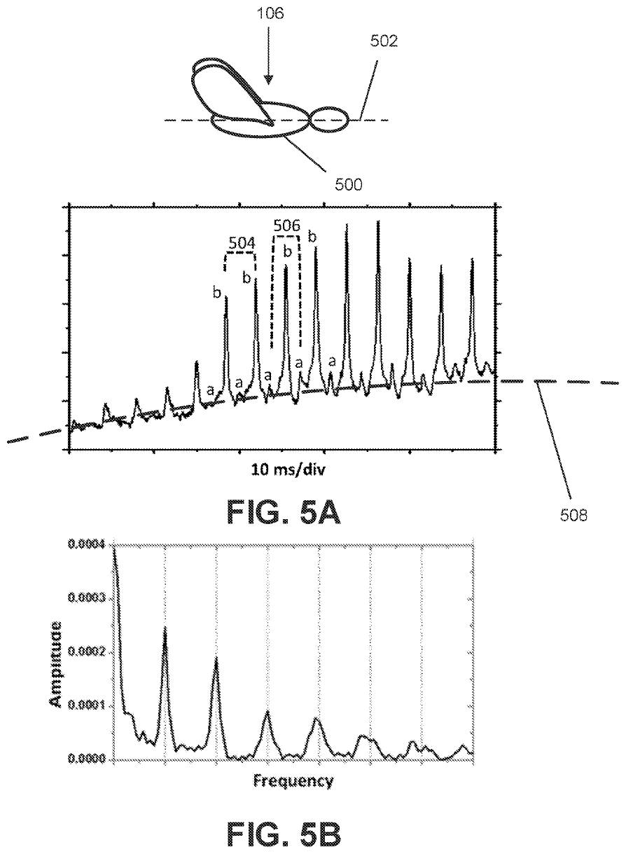

In one embodiment, a database of known waveform signatures is maintained. Waveform signatures are datasets of amplitudes and their respective period or frequency in time domain or frequency domain (e.g. FIG. 5A and FIG. 5B). A signal of interest can be compared to this database to classify the aerial object. For example, the database of known signals may include WBF spectra of various flies (e.g. a fruit fly, etc.), various beetles (e.g. a ladybug beetle), various drones (e.g. different models of drones) and various birds. In one embodiment, the comparison is a digital comparison that is performed by the computer processor. By comparing the signal of interest to this database, the airborne object can be classified. The signal patterns in the database may be grouped into predefined groups such as, ambrosia beetles, bionic bird drones, fruit flies, etc.

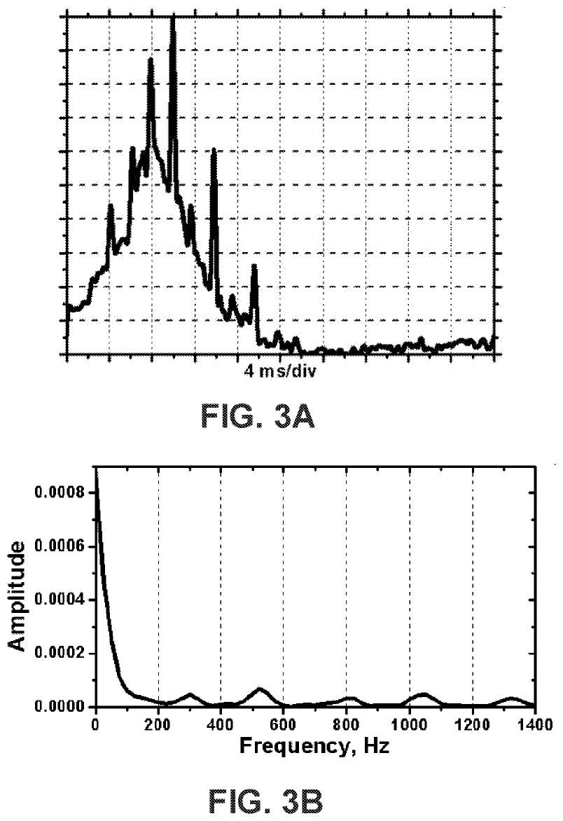

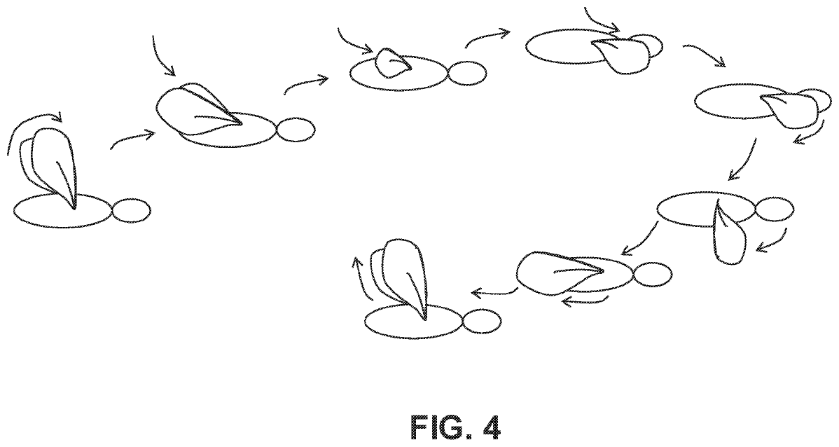

FIG. 3A and FIG. 3B demonstrate a digitized signal and its FFT amplitude spectrum, respectively, collected with the transmitter 102 and the receiver 120 installed in the horizontal side view position as in FIG. 1E to measure the same fruit flies as in FIG. 2A and FIG. 2B. The signal demonstrates a base curve signal (the signal from the body of the airborne object, see base curve signal 508) is more pronounced in the horizontal view and shorter period in the series of periodic peaks. The base curve corresponds to the signal of radiation backscattered by the body of the fruit flies. The periodic peaks correspond to the radiation reflected and scattered by the wings moving laterally to the body of the airborne object. The period of the peaks is 1.9 ms. The corresponding frequency of the AC signal is 525 Hz, which is approximately double the WBF observed in the top view position (FIG. 2A and FIG. 2B). The difference in frequencies is caused by the lateral view to a propelling motion (in contrast to flapping up and down of the wings) in the air as can be seen in FIG. 4.

The signal in FIG. 2A, measured from the top view position, features one peak per one period of wing motion in the horizontal plane. In contrast, the signal in FIG. 3A detected from the horizontal side view position features two peaks per one period of the wing motion. The latter feature is seen in the reflected and scattered radiation 118 because within the one period, wings reflect and scatter electromagnetic radiation towards the receiver 120 twice in this geometry. This feature allows one to determine orientation of the insect (or other airborne object) with respect to the position of the receiver 120. In some embodiments, the transmitter 102 is positioned above a zone of interest to ensure that a top view position is obtained. This may intentionally be done in situations where the top view position (e.g. FIG. 2A and FIG. 2B) gives stronger signals than the horizontal side view position (e.g. FIG. 3A and FIG. 3B). Such situations occur when, for example, the airborne object has a preferred orientation such as an insect preferentially traveling horizontal to the ground.

FIG. 5A is a schematic depiction of data from a bumble bee 500 taken from the top view position. The bumble bee 500 has an orientation shown, in part, by longitudinal axis 502. The orientation, relative to the transmitter optical axis 106, can be determined by evaluating changes in the time domain signal shown in FIG. 5A and in the frequency spectrum shown in FIG. 5B. In the embodiment of FIG. 5A, the signal shows the bumble bee 500 in an orientation that is perpendicular from the transmitter optical axis 106. The resulting signal shows multiple peaks, including peak “a” (which has a period 504) and a peak “b” (which has a period 506). The orientation of the bumble bee 500 can be determined by monitoring changes in one or more of these peaks. FIG. 5B shows the frequency spectrum of the signal from the bumble bee depicted in FIG. 5A.

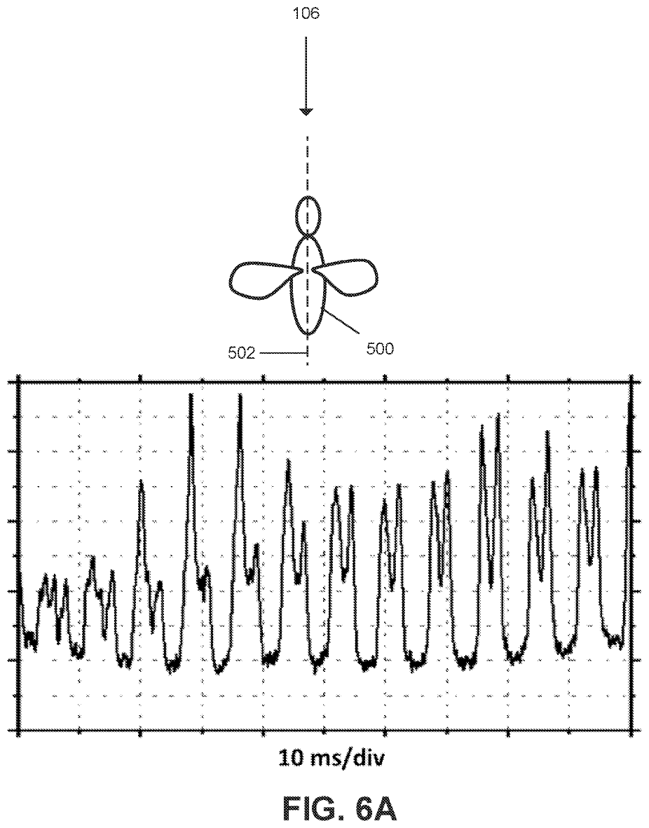

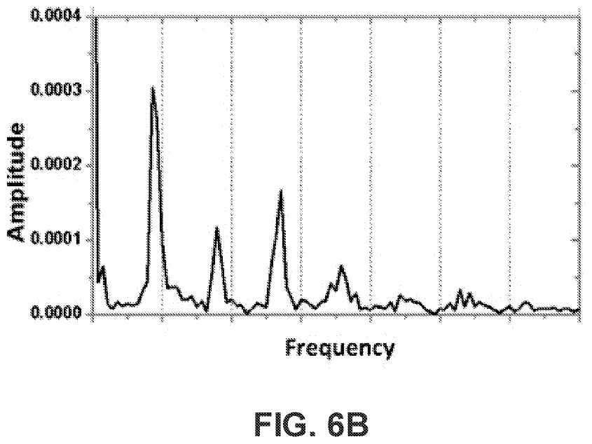

By way of illustration, and not limitation, FIG. 6A depicts the bumble bee 500 in an orientation that is offset 90° from the orientation of FIG. 6A. Due to this change of orientation, the signal peaks in the time domain change in intensity and period. In the example of FIG. 6A, the intensity of peak “a” and “b” is changed. FIG. 6B shows that a change in orientation is also detectable in the frequency spectrum. A decrease in the WBF and a change in the harmonic amplitudes is evident with the change in orientation. As the object transitions between the top view position and the horizontal side view position, the degree of deviation in pitch (and thus the orientation of the airborne object) can be determined by measuring the degree of deviation from the two extremes. Likewise, the deviation in yaw can also be measured by observing changes in the waveform signatures of the airborne object.

The change in peak intensity of peak “a” is shown for illustrative purposes only. In practice, the change in the pattern of peak intensities is dependent on a number of variables, including species of insect or model of aerial drone. For example, in FIG. 6A a change in orientation is detected by observing changes in peak “a” and peak “b”.

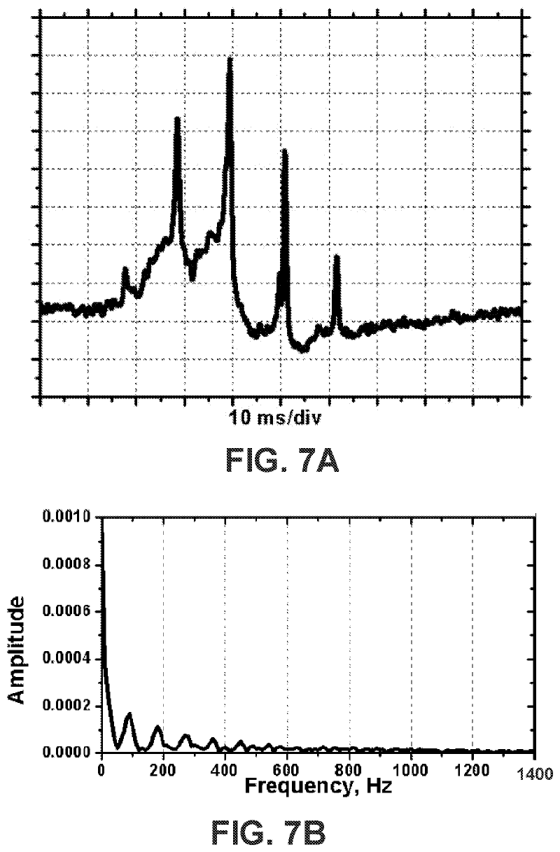

The system 100 can be used to measure wing beat rates for a variety of insects including small beetles such as ladybugs. For example, FIG. 7A and FIG. 7B depict a typical oscilloscope signal and its FFT spectrums. Data was collected from ladybug beetles using the experimental setup with the transmitter 102 and the receiver 120 placed in the top view position. Both pictures demonstrate a WBF of 90 Hz.

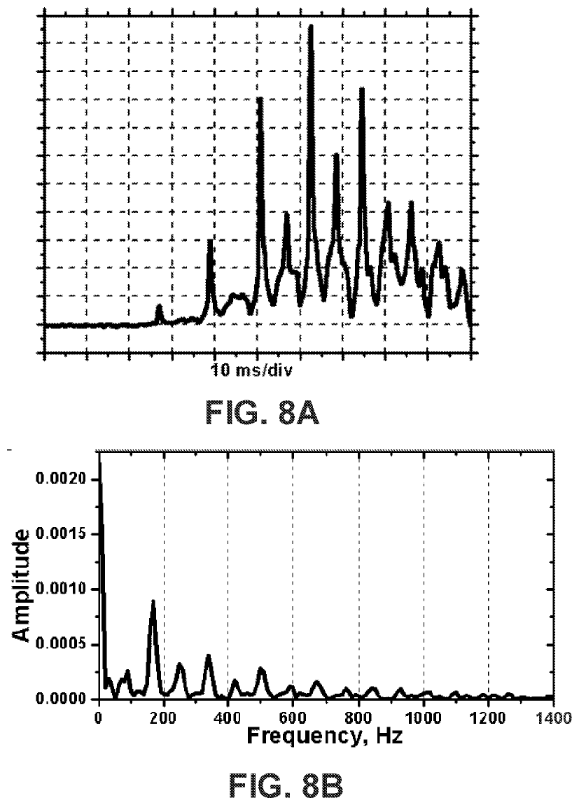

FIG. 8A and FIG. 8B provides oscilloscope data of retrieved waveform in time domain and its FFT spectrum, respectively, collected from the horizontal side view position for the same ladybugs. Both figures demonstrate a 170 Hz WBF.

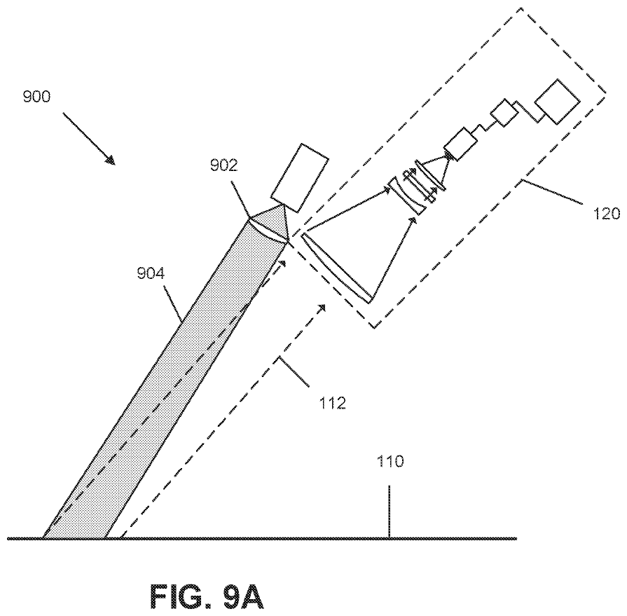

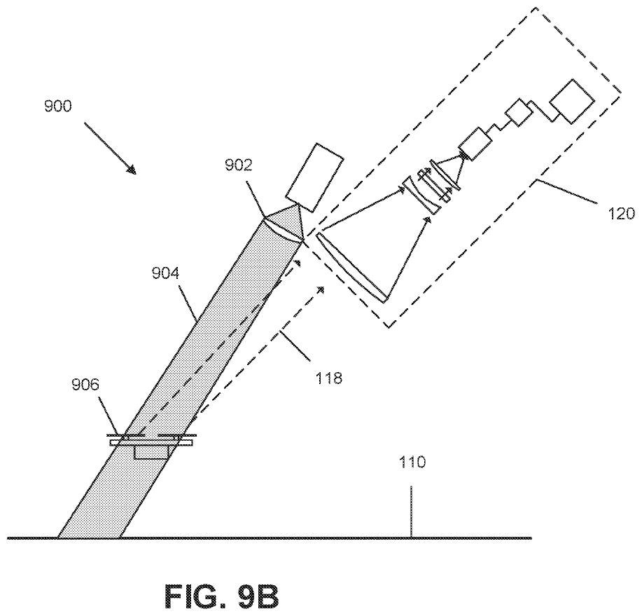

FIG. 9A depicts a system 900 that is substantially similar to system 100 of FIG. 1A except in that the transmitter 102 further comprises a collimating lens 902 at its output. The collimating lens 902 produced a collimated beam 904 of parallel light, rather than a divergent output beam 104.

In FIG. 9B, an airborne object 906 has entered the collimated beam 904. In the embodiment of FIG. 9B, the airborne object 906 is an aerial drone, such as a Helicute H107R X-drone Nano equipped with four identical engines, where each engine has a two-bladed propeller. In another embodiment, the airborne object may be a winged drone (e.g. bionic bird drone).

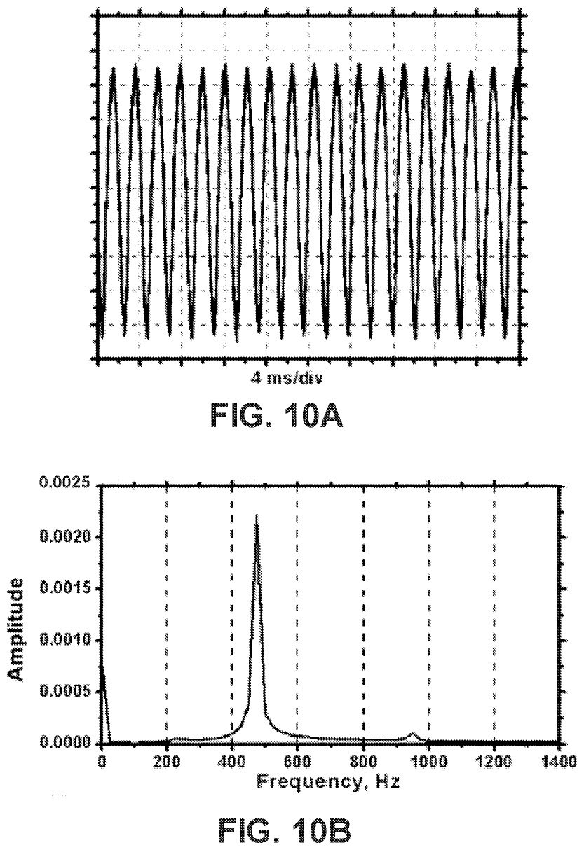

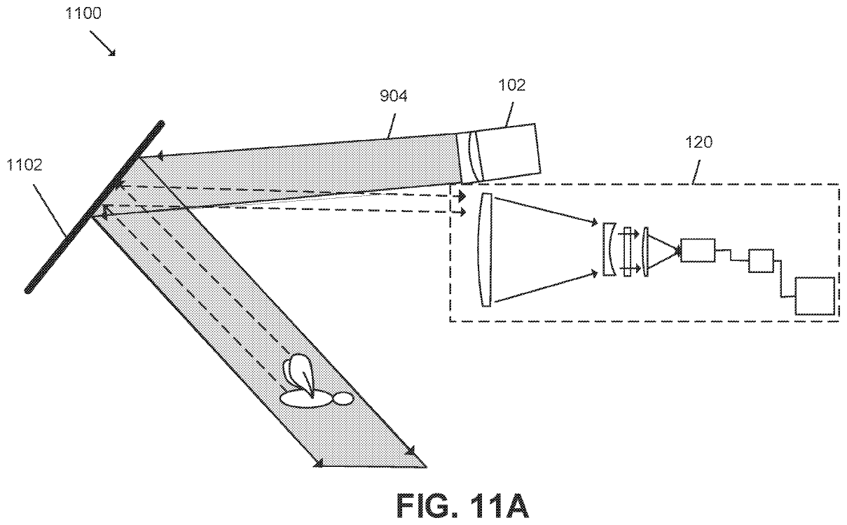

FIG. 10A depicts an oscilloscope signal collected in experiments using a Helicute H107R X-drone Nano, where the transmitter 102 and receiver 120 were installed on an optical bench in a laboratory as it is schematically depicted in FIG. 9A. The detected signal demonstrates a sinusoidal oscillation with a period of 2.1 ms. The sinusoidal oscillations with 2.1 ms period correspond to a modulation frequency of f=1/T=475 Hz.

FIG. 10B depicts an amplitude spectrum obtained by applying an FFT to the sinusoidal signal depicted in FIG. 10A. The first harmonic with a frequency of 475 Hz supports the estimation of the signal frequency found from the time sequence in the sinusoidal signal. Because each propeller is fabricated with two blades, the angular frequency of the propeller's engine is two times less, 237.5 Hz.

The FFT spectrum of the propeller beat is a distinctive parameter of the drone, which can be used to detect and classify drones. Thus, appearance of the sinusoidal signal with the frequency 475 Hz is an evidence that can be used to detect and classify the drone as a Helicute H107R X-drone Nano.

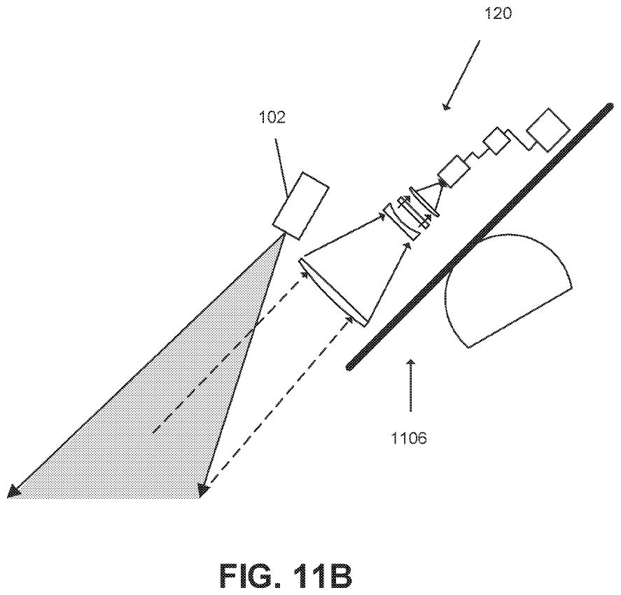

FIG. 11A depicts a system 1100 that includes a scanning system. The scanning system may include an optical scanner or a mechanical scanner. An optical scanner comprises a motorized mirror 1102 (FIG. 11A) that is programmed to maneuver the receiving and transmitting beam, thereby scanning a defined space. A mechanical scanner is comprised of a pan and tilt mount 1106 (FIG. 11B) that moves the transmitter 102 and receiver 120. Each of the scanning systems is configured to move the yaw and/or the pitch of the transmitted beam and received return signal. A scanning algorithm is programmed based on the application. That algorithm may be developed to update its scanning pattern when an airborne object is detected or when conditions require greater resolution and revisit times of a flagged area.

### DETAILED EXAMPLES

The detailed description of the system is illustrated by using Example 1, 2, and 3. Examples 1 & 2 describe the determination of WBF and the insect orientation. In Example 3 a drone propeller's angular frequency is determined.

### Example 1

With reference to FIG. 1A, the system comprises a cw semiconductor laser SCF5 from Coherent, which operates by using near infrared radiation with 810 nm wavelength of depicted as the divergent output laser beam. The power of the laser output radiation was 1.5 W. The transmitter optical axis of the laser, depicted as the dash line, is tilted by a small angle from the vertical axis, depicted as the dash-dot-dash line, to a terrain in FIG. 1A. The laser radiation reflected and scattered by the wings of the insect is collected by a convex lens with a 120 mm focal length and a 2-inch diameter. The radiation scattered off the insect body and wings is detected by a silicon detector, Det100A2 from Thorlabs. The analog electrical signal from the photodiode is electronically amplified, filtered, and converted to a digital signal by using a digitizer, DP03054 from Tektronix. An onboard processor is used to analyze the waveform features of the photodetector signal. MATLAB from MathWorks is used for the analysis.

FIG. 2A depicts an oscilloscope signal collected in the experiments using fruit flies, where the laser and photodetector were installed in the top view position as it is demonstrated in FIG. 1A. The signal demonstrates a low frequency base curve as well as a periodic series of high amplitude peaks with a period of 5 ms. The base curve corresponds to the radiation reflected by the insect's body and the periodic peaks correspond to the radiation reflected and scattered by the insect wings when they fly into the field of view of the apparatus in the horizontal plane. The insect's wing beat period is T=5 ms, which corresponds to a WBF of f=11/T=200 Hz.

FIG. 2B depicts an amplitude vs frequency spectrum calculated using FFT applied to the oscilloscope signal in FIG. 2A. The first harmonic with a frequency of 200 Hz demonstrates the highest amplitude of AC signal, which supports the estimation of the WBF found from the time sequence of peaks and known from published studies.

FIG. 3A and FIG. 3B demonstrate the digitized signal and its FFT amplitude spectrum, respectively, collected with the transmitter 102 and receiver 120 installed in a horizontal side view position to measure the same fruit flies. The signal demonstrates a strong low frequency component (i.e. the base curve signal) and shorter period in the series of periodic peaks. The low frequency component corresponds to the signal of radiation scattered by the insect's body. The periodic peaks correspond to the radiation reflected and scattered by the wings moving laterally to the insect's body. The period of the peaks is 1.9 ms. The corresponding frequency of the detected AC signal is 525 Hz, which is approximately twice higher than the WBF observed from the top point of view. The difference in frequencies is caused by the lateral view to a propelling motion of wings in the air.

### Example 2

The apparatus may be used to detect and classify insects including small beetles such as ladybugs. As in Example 1, FIG. 7A and FIG. 7B depict typical oscilloscope signals and their FFT spectrums. Data was collected from ladybug beetles using the experimental setup with the laser source and photodiode placed in the top view position. Both pictures demonstrate a WBF of 90 Hz.

FIG. 8A and FIG. 8B demonstrate the oscilloscope output of retrieved waveform in the time domain and its FFT spectrum, respectively, collected from the side view position. Both figures demonstrate a 170 Hz WBF.

### Example 3

FIG. 9A and FIG. 9B depict the apparatus set up comprising a continuous wave (cw) semiconductor laser SCF5 from Coherent, which is tuned to emit the electromagnetic radiation with the wavelength of 810 nm. The laser beam is collimated by using the lens. The power of the collimated laser beam is tunable in the range from 0 to 1.5 W. The transmitter optical axis of the laser depicted as the dash-dot line is directed toward the drone, which is Helicute H107R X-drone Nano equipped with four identical engines, where each engine wears the propeller of two blades.

The laser radiation scattered by the drone is partially collected by the lens with a 120 mm focal length and a 2-inch diameter. The collected radiation is filtered by using a narrow-band optical interference filter for 810 nm radiation from Edmund Optics placed at the front of silicon photodiode, Det100A2 from Thorlabs, used as the detector. The analog electrical signal from the photodiode is amplified, filtered, and converted to a digital signal by using the digitizer of DP03054 oscilloscope from Tektronix. An onboard processor of a personal computer is used to analyze the waveform features of the photo-detected signal. Codes developed using MATLAB are used for applying an FFT of the waveform signals between the time to frequency domains.

FIG. 10A depicts an oscilloscope signal collected in the experiments by using Helicute H107R X-drone Nano, where the drone, laser and photodetector were installed on an optical bench in the lab as it is schematically depicted in FIG. 9A. The detected signal demonstrates a sinusoidal oscillation with a period of 2.1 ms. The continues sinusoidal oscillations with 2.1 ms period correspond to a modulation frequency of f=1/T=475 Hz.

FIG. 10B depicts a frequency spectrum obtained by applying an FFT to the part of the sinusoidal signal depicted in FIG. 10A. The first harmonic with a frequency of 475 Hz supports the estimation of the signal frequency found from the time sequence in the sinusoidal signal. As each propeller is fabricated with two blades, the angular frequency of the propeller's engine is two times less, 237.5 Hz.

The FFT spectrum of the propeller beat is a distinctive parameter of the drone, which can be used to detect and identify drones. Thus, appearance of the sinusoidal signal with the frequency 475 Hz is an evidence that can be used to detect and identify drone as Helicute H107R X-drone Nano.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for detecting an airborne object, the method comprising:
emitting electromagnetic radiation as a transmitter beam of a predetermined wavelength from a transmitter comprising a radiation source selected from a group consisting of a continuous wave mode radiation source, a pulse mode radiation source and a combination thereof, wherein the transmitter beam overlaps with a field of view of a receiver and an airborne object is present within the field of view, the airborne object comprising a moving airfoil selected from a group consisting of at least one moving wing and at least one moving propeller, wherein the electromagnetic radiation interacts with the moving airfoil to produce reflected and scattered radiation;
detecting, with the receiver, the reflected and scattered radiation, wherein the receiver comprises;
an optical receiving antenna for receiving the reflected and scattered radiation, thereby producing collected radiation;
a photodetector for converting the collected radiation to an analog signal;
a digitizer for converting the analog signal to a digital signal; and
a computer processor;
analyzing, with the computer processor, the digital signal to produce analyzed data.

2. The method as recited in claim 1, the method comprising actuating a scanner to move the transmitter and the receiver.

3. The method as recited in claim 1, wherein the transmitter comprises both a continuous wave mode radiation source and a pulse mode radiation source that are unified by a beam splitter into a single transmitter beam.

4. The method as recited in claim 1, wherein the analyzing comprises determining a waveform signature of the digital signal in the time domain.

5. The method as recited in claim 1, wherein the analyzing comprises performing a fast Fourier transform (FFT) of the digital signal.

6. The method as recited in claim 1, wherein the transmitter emits the electromagnetic radiation in a continuous wave mode.

7. The method as recited in claim 1, wherein the transmitter emits the electromagnetic radiation in a pulsed mode.

8. The method as recited in claim 1, wherein the airborne object is a winged insect and the method further comprises classifying the wing insect by species based on the analyzed data.

9. The method as recited in claim 1, wherein the airborne object is a winged animal and the method further comprises classifying the wing animal by species based on the analyzed data.

10. The method as recited in claim 1, wherein the airborne object is a winged drone and the method further comprises classifying the winged drone by model based on the analyzed data.

11. The method as recited in claim 1, wherein the airborne object is a winged object and the method further comprises counting a number of winged objects that were detected by the receiver over a predetermined period time.

12. The method as recited in claim 1, wherein the airborne object is a winged object, and the analyzing include determining a wing beat frequency (WBF) based on the analyzed data.

13. The method as recited in claim 1, wherein the airborne object is a winged object that has an orientation and the receiver has an optical axis, and the analyzing include determining the orientation of the winged object with respect to the optical axis of the receiver based on the analyzed data.

14. The method as recited in claim 1, wherein the airborne object is a winged animal that has an orientation and the receiver has an optical axis, and the analyzing include determining the orientation of the winged animal with respect to the optical axis of the receiver based on the analyzed data.

15. The method as recited in claim 1, wherein the airborne object is a winged drone that has an orientation and the receiver has an optical axis, and the analyzing include determining the orientation of the winged drone with respect to the optical axis of the receiver based on the analyzed data.

16. The method as recited in claim 1, wherein the airborne object is a propeller-driven drone that has an orientation and the receiver has an optical axis, and the analyzing include determining the orientation of the propeller-driven drone with respect to the optical axis of the receiver based on the analyzed data.

17. The method as recited in claim 1, wherein the airborne object is an aerial object with propellers.

18. The method as recited in claim 1, the method further comprising
comparing the digital signal to a database of digital waveform signatures, wherein each signal in the database of digital waveform signatures is grouped into a predefined class; and
classifying the airborne object based on the comparing.

19. The method as recited in claim 1, wherein the transmitter and the receiver are disposed above the field of view such that a top view of the aerial object is detected.

20. The method as recited in claim 1, wherein the airborne object is selected from a group consisting of an airborne animal and an airborne drone.
